(19) United States
(12) Patent Application Publication
(10) Pub. No.: US 2010/0101509 A1
(43) Pub. Date: Apr. 29, 2010

(54) WATER HEATERS WITH SEALED DOOR ASSEMBLIES

(76) Inventors: Emadeddin Y. Tanbour, Johnson City, TN (US); Rodney R. Syler, Franklin, TN (US); Mark A. Murphy, Nashville, TN (US); Marcus E. McAnally, Nashville, TN (US)

Correspondence Address: MICHAEL BEST & FRIEDRICH LLP, 100 E WISCONSIN AVENUE, Suite 3300, MILWAUKEE, WI, 53202, US

(21) Appl. No.: 12/260,200

(22) Filed: Oct. 29, 2008

(51) Int. Cl. F24H 9/02; F24H 9/00; E06B 7/16

(52) U.S. Cl. 122/19.2; 122/19.1; 49/493.1; 49/483.1

(57) ABSTRACT

A water heater door assembly includes a seal positioned over an access opening in a water heater combustion chamber and having at least one opening through which a fuel supply line extends at least partly between a burner in the combustion chamber and a gas control valve, the seal including a pair of complementary seal pieces adjacent each other in sealing contact with at least edge portions of the access opening and in sealing contact with the fuel supply line and a retainer affixed to edge portions of the combustion chamber adjacent the access opening which sealingly holds the seal pieces over the access opening.

### TECHNICAL FIELD

This disclosure relates to water heaters, particularly to water heaters that have door assemblies, such as those for water heater combustion chambers.

### BACKGROUND

Gas fired water heaters traditionally have a water container placed above or adjacent to a combustion chamber and burner assembly. The burner assembly is controlled by a gas control valve which may be responsive to user input, such as a temperature setting. The burner assembly may have a main gas line extending from the gas control valve, through the combustion chamber wall or door, and to the burner. Gas lines have been constructed using various configurations and materials. By way of example, rigid tubing has been used where possible and in some cases threaded fittings are used to connect the rigid tubing to flexible tubing.

It could be beneficial to provide a sealed door assembly that is simple, compact, durable, tamper-resistant and economical to construct.

### SUMMARY

We provide a water heater door assembly comprising a seal positioned over an access opening in a water heater combustion chamber and having at least one opening through which a fuel supply line extends at least partly between a burner in the combustion chamber and a gas control valve, the seal comprising a pair of complementary seal pieces adjacent each other in sealing contact with at least edge portions of the access opening and in sealing contact with the fuel supply line; and a retainer affixed to edge portions of the combustion chamber adjacent the access opening which fixes the seal pieces over the access opening in a sealed condition.

We also provide a water heater door assembly comprising a base plate sized and shaped to substantially sealingly cover an access opening in a water heater combustion chamber and having at least one opening through which a fuel supply line extends at least partly between a burner in the combustion chamber and a gas control valve, a flexible gasket affixed to edge portions of the combustion chamber around the at least one opening, and a seal plate positioned over the at least one opening and having a through hole that is sized and shaped to substantially sealingly receive the fuel supply line, the seal plate having an outer edge portion that engages the gasket around the at least one opening and substantially seals the seal plate to the base plate.

We further provide a water heater door assembly comprising a base plate sized and shaped to substantially sealingly cover an access opening in a water heater combustion chamber having at least one opening through which a fuel supply line extends at least partly between a burner in the combustion chamber and a gas control valve, a ferrule positioned on the fuel supply line proximate the access opening, a compression seal positioned at least partly within the opening and having a through hole that is sized and shaped to receive the fuel supply line, the compression seal comprising: 1) a barrel portion that extends through the opening, has threads on at least a portion of its outer surface and a bore through which the fuel supply line extends; and 2) a flange extending radially outwardly from the barrel portion along an inner surface of the base plate and a compression nut positioned on the fuel supply line along an outer surface of the base plate and having threads on an interior surface that threadingly engage the threads of the compression seal such that the fuel supply line is substantially sealed to the base plate through compression of the ferrule, the compression seal and the compression nut.

We further provide a water heater door assembly comprising a fuel supply line that extends at least partly between a burner in a water heater combustion chamber and a gas control valve, a base plate sized and shaped to substantially sealingly cover an access opening in the combustion chamber and having at least one opening through which the fuel supply line extends, a seal plate extending radially outwardly from the fuel supply line and positioned over an edge portion of the access opening along an inner surface of the combustion chamber, a rib extending radially outwardly from the fuel supply line and positioned proximate the edge portion of the access opening at an outer surface of the combustion chamber and a retainer ring positioned on the fuel supply line exteriorly of the outer surface and having a diameter that is at least partly greater than the diameter of the access opening such that a distal portion of the retainer ring engages the outer surface, and a proximal portion having a diameter at least partly smaller than the diameter of the rib which engages the rib and applies spring generated force such that the seal plate sealingly engages the inner surface.

We further provide a water heater door assembly comprising a base plate sized and shaped to substantially sealingly cover an access opening in a water heater combustion chamber and having at least one opening through which a fuel supply line extends at least partly between a burner in the combustion chamber and a gas control valve and a seal positioned within the opening and having a through hole that is sized and shaped to receive the fuel supply line, the seal comprising a deformable material sealed to the opening and to the fuel supply line by a deforming force.

We further provide a water heater comprising a water container, a combustion chamber adjacent the water and having an access opening and a floor and/or wall, a burner associated with the combustion chamber and arranged to combust fuel to heat water in the water container, a control valve that regulates fuel flow from an external fuel force, a fuel line that extends at least partly between the burner and the control valve, a door assembly comprising: 1) a base plate sized and shaped to substantially sealingly cover the access opening and having at least one opening through which the fuel supply line extends; and 2) a seal positioned at least partly within or over the opening and having a through hole that is sized and shaped to sealingly receiving the fuel supply line and a fuel supply line retainer bracket positioned on the floor or the wall that has a receiving portion sized and shaped to receive and hold a distal portion of the fuel supply line in a selected position with a friction fit.

We further provide a water heater comprising a water container, a combustion chamber adjacent the water and having an access opening, a burner associated with the combustion chamber and arranged to combust fuel to heat water in the container, a control valve that regulates fuel flow from an external fuel source having a fuel outlet, a fuel line that extends at least partly between the burner in the combustion chamber and the control valve, a door assembly comprising: 1) a base plate sized and shaped to substantially sealingly cover an access opening in a water heater combustion chamber and having at least one opening; and 2) a seal positioned at least partly within or over the opening and having a through hole that is sized and shaped to sealingly receive the fuel supply line, a substantially tubular connector extending between the fuel outlet and the fuel supply line and having one end portion slidable with respect to the fuel outlet or the fuel supply line and an opposed end portion fixed with respect to the fuel outlet or the fuel supply line, wherein the end portion that is slidable comprises a sealing ring that sealingly and slidably contacts an inner surface of the fuel outlet or the fuel supply line and a retainer positioned on the fuel outlet of the fuel supply line that engages the connector and prevents the connector from disengaging from the fuel outlet or the fuel supply line.

### BRIEF DESCRIPTION OF THE DRAWINGS

FIG. 1 is a schematic front elevational view of a water heater.

FIG. 2 is a schematic side elevational view of the water heater of FIG. 1.

FIG. 3 is a schematic front elevational view, taken partly in section, of the lower portion of a water heater of the type shown in FIG. 1.

FIG. 4 is a schematic perspective view, partly broken away, of the lower portion of a water heater.

FIG. 5 is a schematic perspective view of a door assembly for a water heater of the type shown in FIGS. 1-4.

FIG. 6 is a schematic perspective view of a portion of a seal piece taken from the door assembly of FIG. 5.

FIG. 7 is a perspective view of another door assembly suit for use in conjunction with the water heaters of the type shown in FIGS. 1-4.

FIG. 8 is a sectional view taken along the lines and arrows A-A of FIG. 7.

FIG. 9 is a partial cross-sectional view of a water heater door assembly and gas supply line.

FIG. 10 is a partial cross-sectional view of another door assembly and gas supply line.

FIG. 11 is a schematic perspective view of the door assembly of FIG. 10 oriented from inside a combustion chamber.

FIG. 12 is a partial schematic cross-sectional of a door assembly, gas supply line and gas supply line retainer bracket.

FIG. 13 is a partial schematic cross-sectional view of a door assembly, gas supply line and gas supply line bracket.

FIG. 14 is a partial schematic cross-sectional view of a door assembly and gas supply line.

FIG. 15 is a partial schematic cross-sectional view of a gas supply line connected to an outlet of a fuel control valve.

FIG. 16 is a top plan view of a retainer ring taken from FIG. 5.

### DETAILED DESCRIPTION

It will be appreciated that the following description is intended to refer to specific aspects of the representative structures selected for illustration in the drawings and is not intended to define or limit the substance of this disclosure, other than in the appended claims.

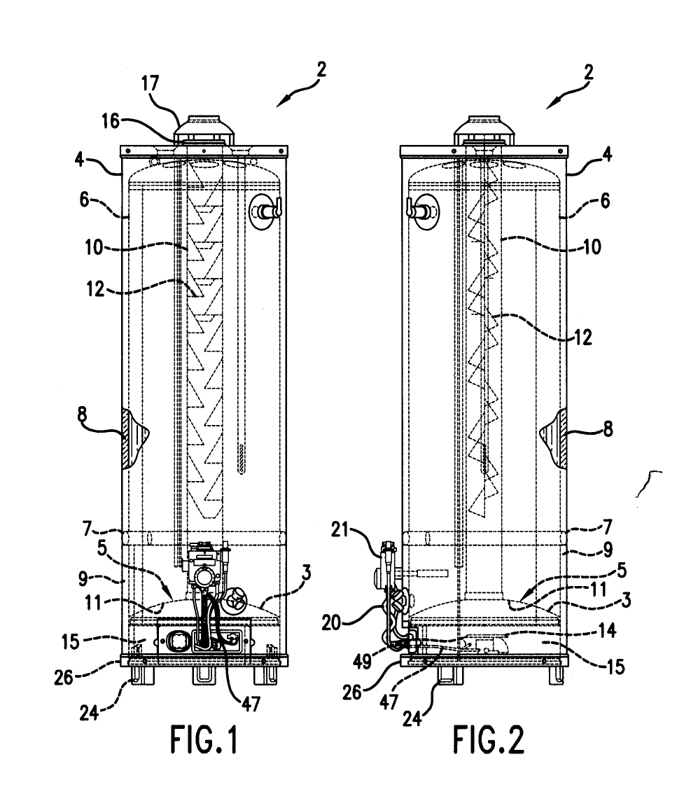

Turning now to the drawings in general and FIGS. 1-4 in particular, the number “2” designates a storage type gas water heater 2. Water heater 2 includes jacket 4 which surrounds a water tank 6 and a main burner 14 in a combustion chamber 15. The term “water tank” or “water container” can include conventional storage type water tanks. However, it can include other types of structures through which water passes and/or is retained for a period of time whether extended or just momentary. Thus, the water tank or container can also be as simple a structure as a pipe or conduit through which water flows.

Passing through the center of the tank 6 is a flue 10, in this instance incorporating a series of baffles 12 to better transfer heat generated by the main burner 14. Water tank 6 is preferably of mains pressure capability and is capable of holding heated water. Water tank 6 is preferably insulated by foam insulation 8. Alternative insulation may include fiberglass or other types of fibrous insulation, heating retaining material and the like. Fiberglass insulation 9 surrounds combustion chamber 15 and the lowermost portion of water tank 6. It is possible that heat-resistant foam insulation can be used if desired. A foam dam 7 separates foam insulation 8 and fiberglass insulation 9.

Located underneath the water tank 6, within the combustion chamber 15, is the main burner 14 which uses any type of fuel such as oil, natural gas or other gases such as LPG, for example. Other suitable fuels may be substituted. Fuel is provided to the main burner 14 through the fuel supply line 20, which is fluidly connected to fuel control valve 21. Fuel control valve 21 supplies fuel to burner 14 by way of fuel supply line 20. Main burner 14 combusts a fuel and air mixture and the hot products of combustion resulting rise up through flue 10, possibly with heated air. Water tank 6 is lined with a glass or other type of coating for corrosion resistance. Bottom 5 of water tank 6 is preferably coated on both its interior facing surface 3 and exterior facing surface 11. The thickness of the coating of exterior facing surface 11 may be about half of the thickness of interior facing surface 3. Also, the lower portion of flue 10 is preferably coated on both of its opposing surfaces. The surface exposed to the flue gases has a thickness about half the thickness of the surface exposed to water in water tank 6. The glass coating helps to prevent scaling of the flue and water tank surfaces.

Combustion chamber 15 also contains a pilot burner 49 connected to fuel control valve 21 by pilot fuel supply line 47. A sheath 52, preferably made of copper, contains wires (not shown) from a flame detecting thermocouple 51 to cause, in the absence of a flame at pilot burner 49, fuel control valve 21 to shut off the gas supply. Thermocouple 51 may be selected from those known in the art. RobertShaw Model No. TS 750U may be used, for example.

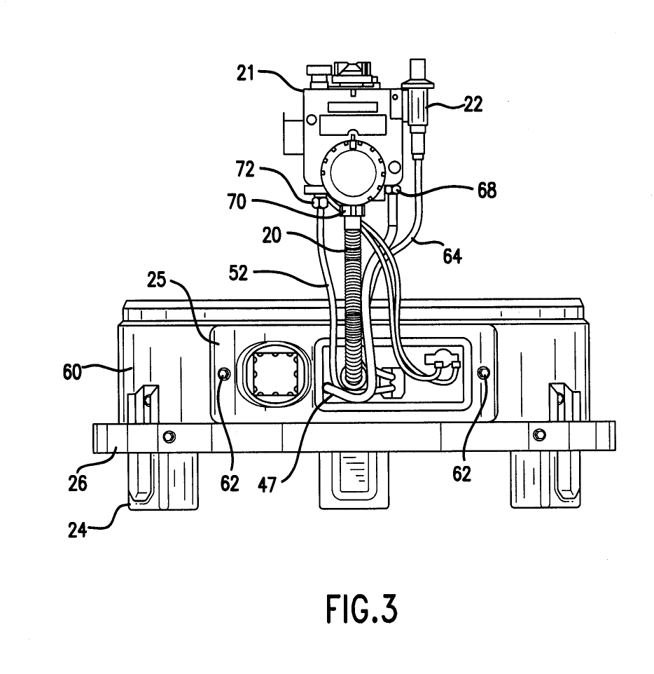

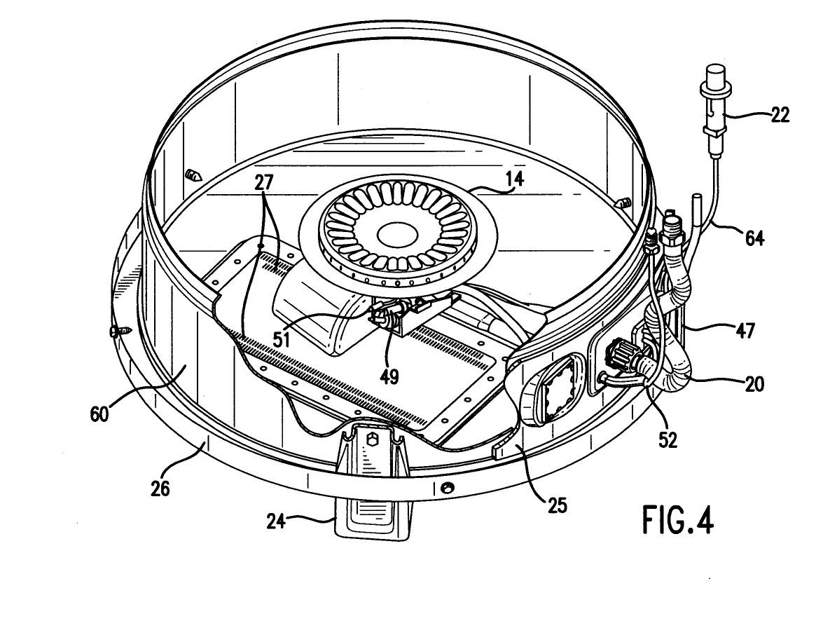

FIGS. 3 and 4 particularly show fuel supply line 20 and pilot fuel supply line 47 extending outwardly from a door 25, which provides access to the combustion chamber 15. Door 25 is removably sealable to skirt 60 that forms the side wall of combustion chamber 15. Door 25 is held into position by a pair of screws 62 or by any other suitable means. Pilot fuel supply line 47 and fuel supply line 20 pass through door 25 in a substantially fixed and sealed condition. Sheath 52 also extends through door 25 in a substantially fixed and sealed condition as does igniter line 64. Igniter line 64 connects on one end to an igniter button 22 and a piezo igniter. Igniter button 22 can be obtained from Channel Products, for example. Each of pilot fuel supply line 47, fuel supply line 20 and sheath 52 are removably connectable to fuel control valve 21 by compression nuts 68, 70 and 72, respectively. Each of compression nut 68, 70 and 72 are threaded and threadingly engage control valve 21. Other means of connecting may be employed as alternatives.

The products of combustion pass upwardly and out the top of jacket 4 via flue outlet 16 after heat has been transferred from the products of combustion. The flue outlet 16 discharges conventionally into a draft diverter 17 which in turn connects to an exhaust duct leading outdoors.

Water heater 2 is preferably mounted on legs 24 to raise bottom pan 26 off the floor. Bottom pan 26 preferably has one or more apertures 27 or some other means that receive combustion air. Where bottom pan 26 meets jacket 4, the mating surfaces (made up from surfaces of bottom pan 26 and jacket 4) can be sealed thoroughly to prevent ingress of air or any flammable gas or vapor. The cylindrical wall of jacket 4 (the majority of gas water heaters are cylindrical. However, a cubic or other shaped jacket 4 may be utilized) can be sealed substantially gas tightly so that no openings or breaks remain upon assembly and installation.

In particular, gas, water, electrical, control or other connections, fittings or plumbing, wherever they pass through the jacket 4 or bottom pan 26 may be sealed substantially airtightly. The joining area of bottom pan 26 to jacket 4 and service entries or exits to the jacket 4 need not be sealed airtightly. It is preferred, however, that the space around burner 14 be substantially air/gas tight except for means to supply combustion air.

Turning now to FIG. 5, a door assembly 100 is shown in a perspective view. The door assembly 100 comprises a seal 102 positioned over the access opening in combustion chamber 15. The seal may be secured to the skirt 60 (shown in FIG. 3) by any conventional means such as screws, bolts, toggle connectors and the like at holes 104, for example. Other locations for holes 104 are possible.

Seal 102 comprises a pair of complementary seal pieces 106 positioned directly adjacent one another. The ends of seal pieces 106 are also in sealing contact with the edge portions of the access opening in skirt 60. Similarly, a portion of the elongated surfaces 108 are also in sealing contact with edge portions of the access opening of skirt 60.

Seal pieces 106 are held into sealing contact with the outer surface of skirt 60 by retainer bracket 112 which is preferably made from a flat sheet of metallic material that has been formed to fit the shape of the adjacent seal pieces 106. Retainer bracket 112 has a plurality of openings to accommodate various portions of the water heater. For example, opening 114 allows for the passage of main fuel supply line 20 through retainer bracket 112 and into combustion chamber 115. Similarly, opening 116 permits pilot fuel supply line 47 to pass through retainer 112 and into combustion chamber 15. Other openings 118 accommodate other structures such as electrical wires 120 and allow them to also extend into combustion chamber 15.

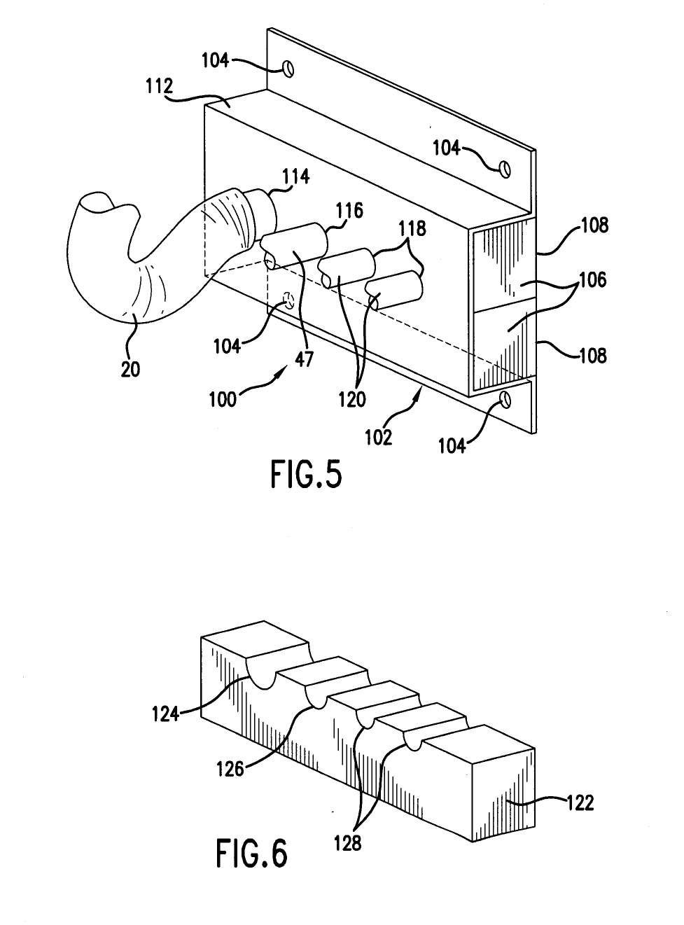

Each complementary seal piece is in the shape of a parallelepiped 122 as shown in FIG. 6. Each parallelepiped 122 has a plurality of grooves which accommodate the various structures passing through retainer bracket 112 and into combustion chamber 15. Therefore, there is a substantially semi-circular groove 124 that is sized and shaped to receive fuel supply line 20 and to provide a seal so that air, vapors and exterior gases are substantially sealed from passing into (or out of) combustion chamber 15. There is also a substantially semi-circular shaped groove 126 that accommodates pilot fuel supply line 47. Further, there are additional semi-circular shaped grooves 128 that accommodate wires 120 as shown in FIG. 5.

The complementary parallelepiped has similar semi-circular grooves and the two parallelepipeds are aligned such that the various grooves 124, 126 and 128 are properly aligned and permit the passage of fuel supply line 20, pilot fuel supply line 47 and electrical wires 120, respectively, through skirt 60 and into combustion chamber 15.

Retainer bracket 112 can be made of any number of heat-resistant and stiff materials such as stainless steel sheet, aluminum alloy or the like, for example. On the other hand, seal pieces 106 should preferably be made of a heat-resistant, but somewhat flexible material, such as silicon rubber that will provide a good sealing surface against fuel supply line 20, pilot fuel supply line 47, wires 120 and the like.

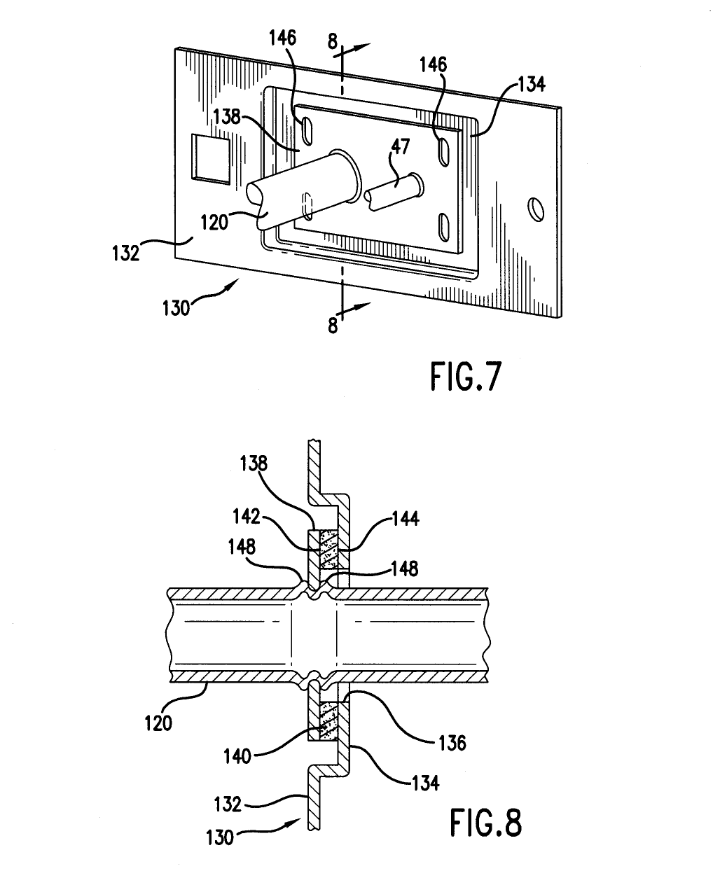

FIGS. 7 and 8 show a different type of door assembly 130. Door assembly 130 includes a base plate 132 which has a substantially square or rectangular indented portion 134. An access opening 136 is cut into indented portion 134. Seal plate 138 is positioned to cover access opening 136. A fiber or silicon gasket 140 is positioned between the edge portions 142 of access opening 136 and the edge portion 144 of indented portion 134. Seal plate 138 has a plurality of holes 146 through which fasteners such as screws, bolts and the like are used to secure and seal base plate 138 to indented portion 134.

Seal plate 138 includes a plurality of openings through which fuel supply line 120 and pilot fuel supply line 47 extend. Both of fuel supply line 120 and pilot fuel supply line 47 are sealed to seal plate 138. Any number of means may be used to seal the fuel lines 120 and 47 to seal plate 138. However, FIG. 8 in particular shows fuel supply line 120 “swaged” to base plate 138. The swaging process provides for a pair of ribs 148 on opposed sides of seal plate 138. Those ribs are formed from fuel supply line 120 itself and fix fuel supply line 120 into a selected, desired position in a manner that is substantially sealed to the passage of air and/or localized vapors inwardly or outwardly of combustion chamber 15.

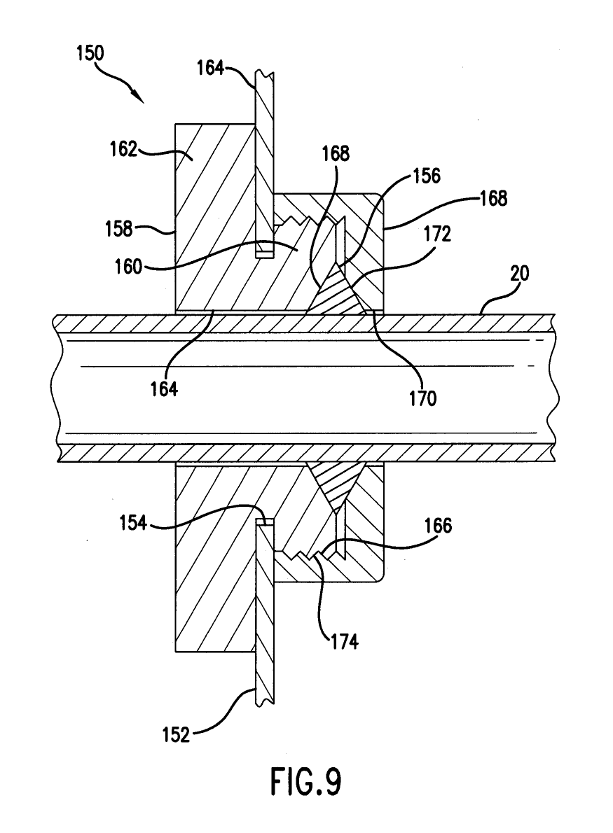

FIG. 9 shows yet another door assembly 150 that includes a base plate 152 having an access opening 154 through which fuel supply line 20 can extend. The door assembly 150 also comprises a ferrule 156 positioned on fuel supply line 20. The inner diameter of ferrule 156 and the outer diameter of fuel supply line 20 are similar, but the outer diameter of fuel supply line 20 is slightly smaller than the inner diameter of ferrule 156 to allow ferrule 156 to slide over fuel supply line 20. The cross section of ferrule 156 is preferably triangular, preferably as an isosceles triangle.

Door assembly 150 also includes a compression seal 158 that includes a barrel portion 160 and a flange portion 162. Flange portion 162 contacts the inner surface 164 of base plate 152. On the other hand, barrel portion 160 has a bore 164 that extends longitudinally therethrough. At least a portion of the outer surface of barrel portion 160 has threads 166. The barrel portion extends through opening 154 and outwardly of base plate 152. Barrel portion 160 also has a tapered surface 168 that contacts one side of the ferrule 156 that has a triangular cross section.

Door assembly 150 also includes a compression nut 168. Compression nut 168 has an opening 170 through which fuel supply line 20 extends. That opening also has a tapered portion 172 that contacts an opposed side of ferrule 156. Compression nut 168 also has threads 174 on an inner surface thereof that threadingly engage threads 166 of compression seal 158. The compression of the compression nut 168, ferrule 156 and compression seal 158 provide a seal against the passage of air or vapors into or out of combustion chamber 15 and fixes fuel supply line 20 into a desired, selected position.

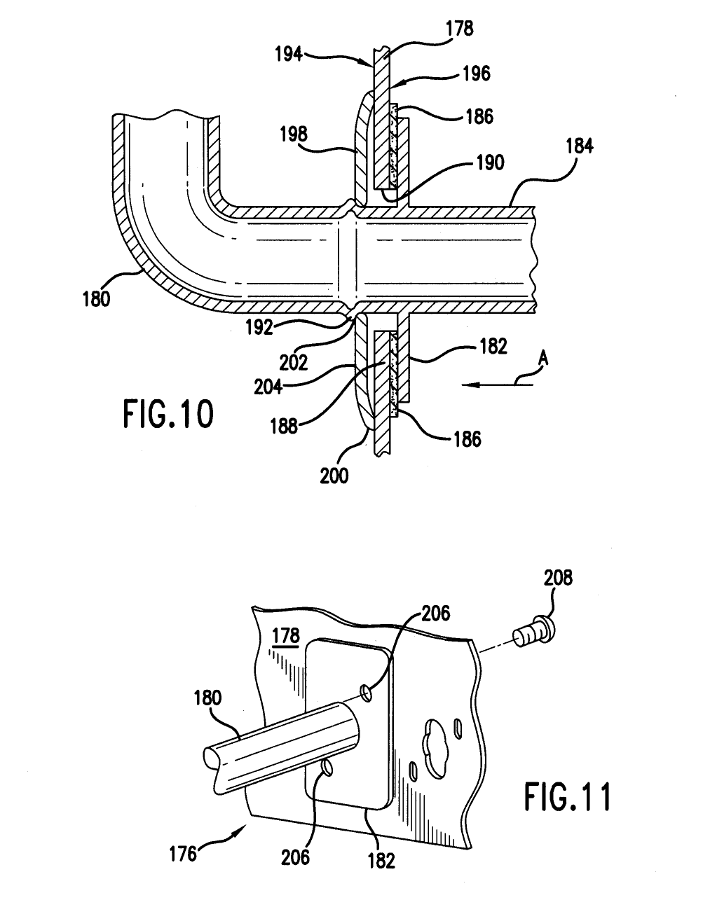

FIGS. 10 and 11 show another door assembly 176 that may be used in conjunction with the type of water heaters shown in FIGS. 1-4. Door assembly 176 includes a base plate 178 and a fuel supply line 180. The fuel supply line includes a seal plate 182 that extends radially outwardly from the main tubular portion 184 of fuel supply line 180. Seal plate 182 contacts a gasket 186 that is positioned on an edge portion 188 of opening 190 in base plate 178. The gasket 186 may be made out of any number of materials such as silicon so long as they are heat-resistant and lend themselves to providing a good seal contact between seal plate 182 and edge portion 188.

The tubular portion 184 of fuel supply line 180 also has a rib 192 that extends radially outwardly. Rib 192 extends outwardly proximate the outer surface 194 of base plate 178, whereas seal plate 182 extends radially outwardly proximate the inner surface 196 of base plate 178.

A retainer ring 198 acts as a spring that provides a bias between rib 192 and the outer surface 194 of base plate 178. This bias causes seal plate 182 to move in the direction of arrow A so that it is in a sealing position against gasket 186.

Retainer ring 198 has a distal portion 200, a proximal portion 202 and a middle portion 204. The distal portion 200 is angled in a plane that is different from the plane of middle portion 204 in a direction toward base plate 178. On the other hand, proximal portion 202 is angled in a plane that is different from the plane of middle portion 204 toward rib 192.

It is also possible to employ holes 206 and a screw 208 to further affix seal plate 182 to base plate 178.

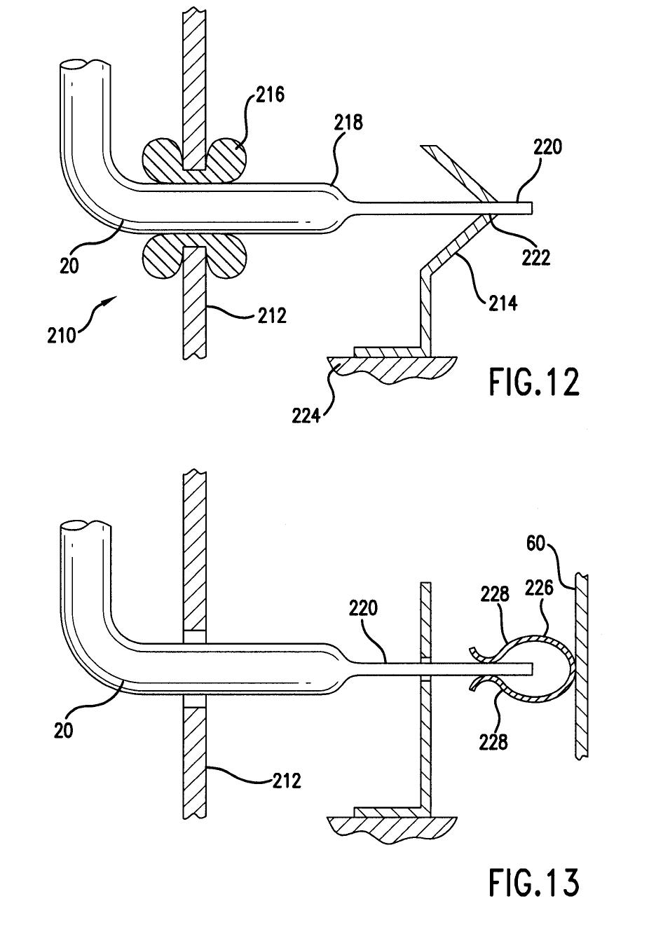

FIG. 12 shows a door assembly 210 wherein fuel supply line 20 is fixed to base plate 212 and, on a distal end thereof, is attached to a bracket 214 in a way to further stabilize fuel supply line 20 in a desired, fixed position so that burner 14 (shown in FIGS. 1, 2 and 4) may be maintained in a proper position.

Fuel supply line 20 is fixed to base plate 112 by a deformed material 216. Deformed material 216 may be made from any number of deformable materials, metallic or non-metallic, so long as they are heat-resistant, stable over time and are susceptible to deformation upon application of specific, high-deforming force. Aluminum is a preferred metal, while silicon rubber is a preferred non-metal.

Bracket 214 stabilizes the distal end portion 218 of fuel supply line 20. The distal portion has a flattened end portion 220 that is friction fit within a slot 222 of bracket 214. Bracket 214 is mounted to floor 224 of water heater 2. Thus, the dimensions of flattened portion 220 are slightly larger than the dimensions of the slot or receiving portion 222 of bracket 214. This causes flat portion 220 to be maintained in the desired position, despite possible jarring movement of water heater 2 during transportation and/or installation.

FIG. 13 shows an alternative construction of a bracket 226 which again retains flattened portion 220 in a desired, selected position. The bracket 226 is a substantially C-shaped bracket that has a pair of spring arms 228 that are biased against each other. Thus, flattened portion 220 is inserted between the spring arms and is retained in place by the biased spring force of the spring arms. Fuel supply line 20 is securely adhered to skirt 60 by bracket 226.

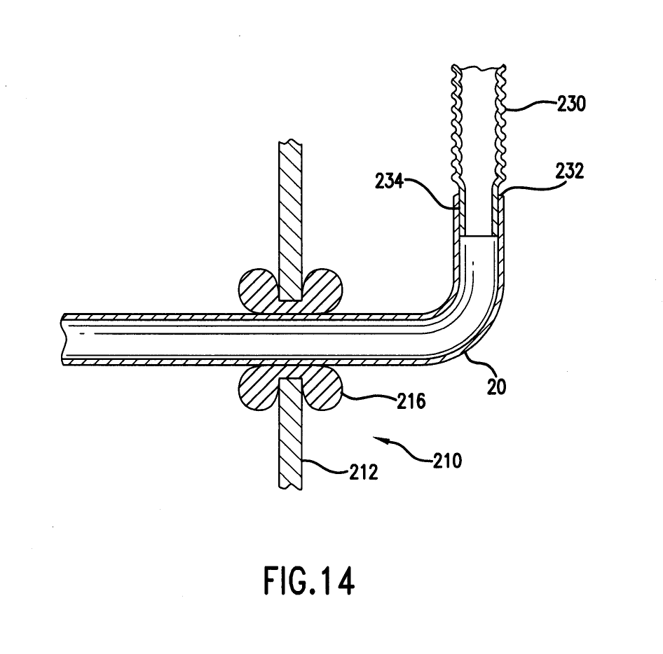

FIG. 14 is somewhat similar to FIG. 12 inasmuch as it discloses a door assembly 210, including the base plate 212 and deformable material forming a seal 216. However, one end of fuel supply line 20 connects to a flexible tube 230 which in turn connects to fuel control valve 21 (shown in FIGS. 1 and 2). Flexible tube 230 can be made out of any number of materials, preferably metallic materials such as stainless steel. A mechanical connection is made at the end 232 of fuel supply line 20 and the reduced diameter portion 234 of flexible tube 230.

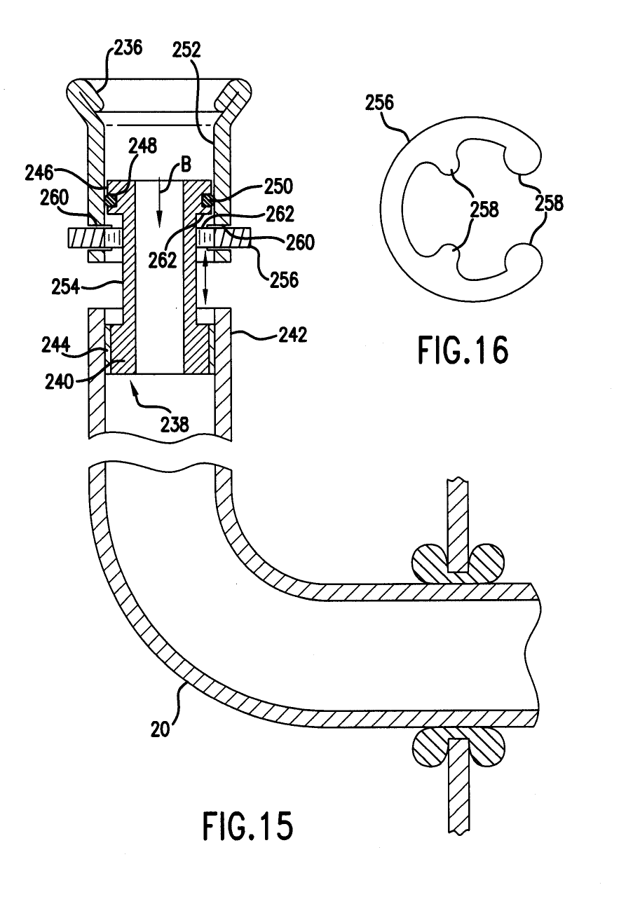

FIGS. 15 and 16 show an alternative connection between fuel supply line 20 and fuel control valve 21 (shown in FIGS. 1 and 2). As particularly shown in FIG. 15, a fuel control valve outlet 236 connects to fuel supply line 20 by way of a connector 238. One end 240 of connector 238 is fixed to an end portion 242 of fuel supply line 20. That connection is by a braze 244 as shown in FIG. 15. It is possible for other means of fixing end portion 240 of connector 238 to end portion 242 such as by soldering, welding, adhesive or the like.

Connector 238 has another end portion 246 that has a groove 248 that contains an O-ring 250. End portion 246 is not fixed to fuel outlet 236. Instead, O-ring 250 is sized so that its outermost diameter is slightly larger than the inner diameter of fuel outlet 236 to create a seal. However, O-ring 250 and the inner surface 252 of fuel outlet 236 are free to move relative to each other. Thus, O-ring 252 may slide along inner surface 252.

Connector 238 also has an elongated indentation 254 that engages retainer ring 256. As shown in FIG. 16, retainer ring 256 is substantially “C”-shaped. It has a plurality of teeth 258 that extend inwardly. Those teeth are free to engage indented portion 254 by way of a plurality of openings 260 in fuel outlet 236. The teeth are free to move along the longitudinal length of indented portion 254. However, retainer ring 256 prevents connector 238 from disengaging from fuel outlet 236 by direct contact between surface 262 of end portion 246 and surface 262 of teeth 258. Thus, retainer ring 256 is in a fixed position with respect to fuel outlet 236 while surface 262 is slidable with respect to fuel outlet 236. The surface 262 impedes sliding movement in the direction of arrow B to line C such that connector 238 cannot disengage from fuel outlet 236.

From the foregoing, it will be appreciated that although specific forms of systems and methods have been described herein for purposes of illustration, various modifications may be made without deviating from the spirit or scope of this disclosure. It is therefore intended that the foregoing detailed description be regarded as illustrative rather than limiting, and that it be understood that it is the following claims, including all equivalents, that are intended to particularly point out and distinctly claim the subject matter this disclosure.

What is claimed is:

1. A water heater door assembly comprising:
a seal positioned over an access opening in a water heater combustion chamber and having at least one through hole through which a fuel supply line extends at least partly between a burner in the combustion chamber and a gas control valve, the seal comprising a pair of complementary seal pieces adjacent each other in sealing contact with at least edge portions of the access opening and in sealing contact with the fuel supply line; and
a retainer affixed to edge portions of the combustion chamber adjacent the access opening which fixes the seal pieces over the access opening in a sealed condition.

2. The door assembly of claim 1, wherein the pair of complementary seal pieces comprise a pair of complementary, substantially parallelepiped fittings, each parallelepiped having a half-barrel shaped groove extending along a surface that forms the through hole when adjacent to a complementary half-barrel shaped groove of the other fitting.

3. The door assembly of claim 1, wherein the seal pieces are made from silicon.

4. The door assembly of claim 1, wherein the retainer comprises:
a substantially flat sheet that covers at least part of each of the pair of parallelepipeds and is fixed to edge portions of the access opening.

5. The door assembly of claim 1, wherein the seal further comprises an opening sized and shaped to sealingly receive a pilot fuel supply line.

6. The door assembly of claim 1, wherein the seal further comprises an opening sized and shaped to sealingly receiving at least one electrical wire.

7. A water heater door assembly comprising:
a base plate sized and shaped to substantially sealingly cover an access opening in a water heater combustion chamber and having at least one opening through which a fuel supply line extends at least partly between a burner in the combustion chamber and a gas control valve;
a flexible gasket affixed to edge portions of the combustion chamber around the at least one opening; and
a seal plate positioned over the at least one opening and having a through hole that is sized and shaped to substantially sealingly receive the fuel supply line, the seal plate having an outer edge portion that engages the gasket around the at least one opening and substantially seals the seal plate to the base plate.

8. The door assembly of claim 7, wherein the gasket is made from a fiber or silicon material.

9. The door assembly of claim 7, wherein the fuel supply line is swaged to the seal plate.

10. The door assembly of claim 7, wherein the seal plate further comprises an opening sized and shaped to sealingly receive a pilot fuel supply line.

11. The door assembly of claim 7, wherein the seal plate further comprises an opening sized and shaped to sealingly receive at least one electrical wire.

12. A water heater door assembly comprising:
a base plate sized and shaped to substantially sealingly cover an access opening in a water heater combustion chamber having at least one opening through which a fuel supply line extends at least partly between a burner in the combustion chamber and a gas control valve;
a ferrule positioned on the fuel supply line proximate the access opening;
a compression seal positioned at least partly within the opening and having a through hole that is sized and shaped to receive the fuel supply line, the compression seal comprising: 1) a barrel portion that extends through the opening, has threads on at least a portion of its outer surface and a bore through which the fuel supply line extends; and 2) a flange extending radially outwardly from the barrel portion along an inner surface of the base plate; and
a compression nut positioned on the fuel supply line along an outer surface of the base plate and having threads on an interior surface that threadingly engage the threads of the compression seal such that the fuel supply line is substantially sealed to the base plate through compression of the ferrule, the compression seal and the compression nut.

13. The door assembly of claim 12, wherein the ferrule has a cross section that is substantially triangular.

14. The door assembly of claim 13, wherein the barrel portion of the compression seal has a tapered portion that engages one triangular side of the ferrule.

15. The door assembly of claim 13, wherein the compression nut has a tapered portion that engages one triangular side of the ferrule.

16. The door assembly of claim 12, wherein the base plate further comprises an opening sized and shaped to sealingly receive a pilot fuel supply line.

17. The door assembly of claim 12, wherein the base plate further comprises an opening sized and shaped to sealingly receive at least one electrical wire.

18. A water heater door assembly comprising:
a fuel supply line that extends at least partly between a burner in a water heater combustion chamber and a gas control valve;
a base plate sized and shaped to substantially sealingly cover an access opening in the combustion chamber and having at least one opening through which the fuel supply line extends;
a seal plate extending radially outwardly from the fuel supply line and positioned over an edge portion of the access opening along an inner surface of the combustion chamber;
a rib extending radially outwardly from the fuel supply line and positioned proximate the edge portion of the access opening at an outer surface of the combustion chamber; and
a retainer ring positioned on the fuel supply line exteriorly of the outer surface and having a diameter that is at least partly greater than the diameter of the access opening such that a distal portion of the retainer ring engages the outer surface, and a proximal portion having a diameter at least partly smaller than the diameter of the rib which engages the rib and applies spring generated force such that the seal plate sealingly engages the inner surface.

19. The door assembly of claim 18, further comprising a gasket positioned between the seal plate and the inner surface.

20. The door assembly of claim 18, wherein the gasket is made from fiber or silicon.

21. The door assembly of claim 18, wherein the retainer ring has a substantially flat inner portion between the distal and proximal portions, the distal portion extends generally in a plane different from a plane of the inner portion and the proximal portion extends in a plane in an opposite direction of the distal portion plane.

22. The door assembly of claim 18, wherein the base plate further comprises an opening sized and shaped to sealingly receive a pilot fuel supply line.

23. The door assembly of claim 18, wherein the base plate further comprises an opening sized and shaped to sealingly receive at least one electrical wire.

24. A water heater door assembly comprising:
a base plate sized and shaped to substantially sealingly cover an access opening in a water heater combustion chamber and having at least one opening through which a fuel supply line extends at least partly between a burner in the combustion chamber and a gas control valve; and
a seal positioned within the opening and having a through hole that is sized and shaped to receive the fuel supply line, the seal comprising a deformable material sealed to the opening and to the fuel supply line by a deforming force.

25. The door assembly of claim 24, wherein the fuel supply line contains a groove aligned with the access opening that is substantially filled with the deformable material.

26. The door assembly of claim 24, wherein the deformable material is aluminum or silicon rubber.

27. The door assembly of claim 24, wherein the seal further comprises an opening sized and shaped to sealingly receive a pilot fuel supply line.

28. The door assembly of claim 24, wherein the seal further comprises an opening sized and shaped to sealingly receive at least one electrical wire.

29. A water heater comprising:
a water container;
a combustion chamber adjacent the water and having an access opening and a floor and/or wall;
a burner associated with the combustion chamber and arranged to combust fuel to heat water in the water container;
a control valve that regulates fuel flow from an external fuel force;
a fuel line that extends at least partly between the burner and the control valve;
a door assembly comprising: 1) a base plate sized and shaped to substantially sealingly cover the access opening and having at least one opening through which the fuel supply line extends; and 2) a seal positioned at least partly within or over the opening and having a through hole that is sized and shaped to sealingly receiving the fuel supply line; and
a fuel supply line retainer bracket positioned on the floor or the wall that has a receiving portion sized and shaped to receive and hold a distal portion of the fuel supply line in a selected position with a friction fit.

30. The water heater of claim 29, wherein the distal portion is substantially flat.

31. The water heater of claim 30, wherein the receiving portion is smaller than the distal portion.

32. The water heater of claim 30, wherein the receiving portion comprises a pair of spring arms biased toward each other.

33. The water heater of claim 29, wherein the fuel line has an indentation formed in its surface and a portion of the seal is deformed into the indentation.

34. The water heater of claim 29, wherein the base plate has an indentation formed in its surface adjacent the opening and a portion of the seal is deformed into the indentation.

35. The water heater of claim 29, further comprising a flexible fuel tube connected to an exterior end portion of the fuel supply line and the control valve.

36. The water heater of claim 29, wherein the flexible fuel tube is stainless steel.

37. A water heater comprising:
a water container;
a combustion chamber adjacent the water and having an access opening;
a burner associated with the combustion chamber and arranged to combust fuel to heat water in the container;
a control valve that regulates fuel flow from an external fuel source having a fuel outlet;
a fuel line that extends at least partly between the burner in the combustion chamber and the control valve;
a door assembly comprising: 1) a base plate sized and shaped to substantially sealingly cover an access opening in a water heater combustion chamber and having at least one opening through which . . . ; and 2) a seal positioned at least partly within or over the opening and having a through hole that is sized and shaped to sealingly receive the fuel supply line;
a substantially tubular connector extending between the fuel outlet and the fuel supply line and having one end portion slidable with respect to the fuel outlet or the fuel supply line and an opposed end portion fixed with respect to the fuel outlet or the fuel supply line, wherein the end portion that is slidable comprises a sealing ring that sealingly and slidably contacts an inner surface of the fuel outlet or the fuel supply line; and
a retainer positioned on the fuel outlet of the fuel supply line that engages the connector and prevents the connector from disengaging from the fuel outlet or the fuel supply line.

38. The water heater of claim 37, wherein the connector has a groove in the slidable end portion that contains the sealing ring.

39. The water heater of claim 37, wherein the sealing ring is an O-ring.

40 The water heater of claim 37, wherein the fixed end portion is fixed to the fuel outlet or the fuel supply line by brazing, soldering, welding or adhesive.

41. The water heater of claim 37, wherein the retainer is substantially C-shaped and snaps around and onto the fuel outlet or fuel supply line.

42. The water heater of claim 37, wherein the fuel outlet or fuel supply line have at least a pair of openings that receive teeth extending from the retainer that engage the connector.

43. The water heater of claim 42, wherein the connector has a groove that engages the teeth.
